(19) United States
(12) Patent Application Publication
(10) Pub. No.: US 2010/0026632 A1
(43) Pub. Date: Feb. 4, 2010

(54) DISPLAY DEVICE

(75) Inventors: Hideyuki ISHIDA, Miyagi-ken (JP); Masami AIHARA, Miyagi-ken (JP); Tsuyoshi HAYAMA, Miyagi-ken (JP); Naoki ITO, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/576,995

(22) Filed: Oct. 9, 2009

Related U.S. Application Data
(63) Continuation-in-part of application No. PCT/JP2008/056791, filed on Apr. 4, 2008.

(30) Foreign Application Priority Data
Apr. 18, 2007 (JP) 2007-109276
Aug. 31, 2007 (JP) 2007-225031

(51) Int. Cl. G06F 3/02; G09G 3/00

(52) U.S. Cl. 345/170; 345/32

(57) ABSTRACT

A reflective display portion includes indication and background portions. A first reflective layer is formed on the indication portion, and a second reflective layer is formed on the background portion on an outer surface of a translucent sheet. Each of the indication and the background portions has a different reflectance value. A light limiting layer is formed on an inner surface of the sheet at an inner side of the second reflective layer so as to reduce a difference of a light transmittance between the indication portion and the background portion. When the external light reflects, the indication portion and the background portion of the reflective display portion are observable owing to the difference of the light reflectance. The light from the light emitting display portion transmits the indication and background portions such that the display content of the light emitting display portion is observable.

### CLAIM OF PRIORITY

This application is a Continuation-in-part of International Application No. PCT/JP2008/056791 filed on Apr. 4, 2008, which claims benefit of Japanese Patent Application No. 2007-109276 filed on Apr. 18, 2007, and Japanese Patent Application No. 2007-225031 filed on Aug. 31, 2007, which are all hereby incorporated by reference.

### BACKGROUND OF THE INVENTION

1. Field of the Invention

The present invention relates to a display device provided for an operation portion of an electronic device, and more particularly, to a display device capable of selectively displaying plural indications on the same location.

2. Description of the Related Art

As the mobile electronic device has a limited number of input portions on the operation surface, the single input portion generally corresponds to plural input operations for realizing the plural functions. For example, each button of the ten-key of the mobile phone has a numerical notation, Roman character notation, and KANA notation marked thereon. The operator is required to determine with respect to the notation based on which he/she operates the respective buttons in accordance with the input mode. With the aforementioned operation display, as the number of modes corresponding to the single input button increases, the malfunction may be more likely to occur.

The mobile electronic device is required to display in accordance with various types of mode on the screen with the limited area. Generally, the liquid crystal display panel capable of switching among various types of display as the display screen. When performing the display in accordance with various modes on the display which is too small to accommodate the liquid crystal panel, it is difficult to produce the display device as described above.

Japanese Unexamined Patent Application Publication No. 2004-195111 discloses the half mirror having the reflective film with high transmittance and the reflective film with low transmittance formed on the same surface. When the light is not applied from the back side, the half mirror allows the entire surface to serve as the mirror when it is seen from the front. When the light source at the back side is turned ON, the respective reflective films with the high transmittance and the low transmittance may be observable distinctively owing to the difference of the transmittance, which allows the characters to be displayed.

Japanese Unexamined Patent Application Publication No. 2005-235671 discloses the display device which allows the key input portion to display plural types of indications. The display device includes a first print layer drawn by the translucent ink at the inner side of the transparent key top, and a second print layer drawn by the light blocking ink at the inner side of the first layer. The light source is provided at the inner side of the second print layer. Under the bright operation environment, the user is allowed to visually identify the first print layer. When the operation environment becomes dark, the light source is turned ON to allow the user to visually identify the second print layer.

The half mirror disclosed in Japanese Unexamined Patent Application Publication No. 2004-195111 is structured to display the character on the reflective film with low transmittance by applying the light from the back side. In other words, the single display portion displays the information of only one type. For example, the fixed display having the indication content unchanged, and the variable display having the indication content switchable in accordance with the mode cannot be displayed simultaneously.

Meanwhile, the display device disclosed in Japanese Unexamined Patent Application Publication No. 2005-235671 is capable of displaying two types of indication display, that is, the indication on the first print layer and the indication on the second print layer on the same portion. When the indication on the second print layer is made visible by turning the light source ON, the first print layer drawn with the translucent ink, which is located to the front is slightly visible as well. The resultant two indications appear overlapped, which makes it difficult for the user to determine as to which display is available.

The art disclosed in Japanese Unexamined Patent Application Publication No. 2005-235671 does not allow the additional third indication display to be kept ON while switching between the two indication displays.

### SUMMARY OF THE INVENTION

The present invention provides a display device capable of selectively displaying plural indications clearly to suppress confusion with respect to the indication displays.

The present invention further provides a display device capable of displaying both the fixed content having the indication kept unchanged, and the variable content having the indication switchable in accordance with the mode.

The present invention provides a display device having a reflective display portion including an indication portion and a background portion each with a different reflectance value with respect to the light, and a light emitting display portion positioned at an inner side of the reflective display portion, which allows a light emitted from the light emitting display portion to transmit the reflective display portion so as to be observed. A difference of a light transmittance value with respect to the light emitted from the light emitting display portion between the indication portion and the background portion is smaller than a difference of the reflectance value between the indication portion and the background portion.

Preferably, the indication portion has the light transmittance value with respect to the light emitted from the light emitting display portion, which is substantially the same as that of the background portion.

In the aforementioned structure, when the light emitting display portion is OFF, the reflective display becomes visible owing to the reflectance difference of the reflection display portion. When the light emitting display is ON, the display content on the light emitting display portion transmits the reflective display portion so as to be visible. The light from the light emitting display portion transmits both the indication portion and the background portion of the reflective display portion in the same way. Accordingly, the display content on the reflective display portion becomes substantially invisible when viewing the display content on the light emitting display portion. This makes it possible to selectively display at least two types of display contents clearly.

In the aforementioned structure, the reflective display portion includes a reflective layer which makes each reflectance value of the indication portion and the background portion different, and a light limiting layer positioned at an inner side of the reflective layer for compensating the difference of the light transmittance value between the indication portion and the background portion caused by the reflective layer.

For example, the reflective display portion includes a translucent substrate. The reflective layer is formed on an outer surface of the substrate, and the light limiting layer is formed on an inner surface of the substrate.

Alternatively, the reflective display portion includes a translucent substrate, and both the reflective layer and the light limiting layer are formed on an inner surface of the substrate. In this case, the illuminating unit for illuminating the reflective display portion may be provided by applying the light to the inside of the substrate. This makes it possible to brightly display the display content on the reflective display portion through the illumination.

The light emitting display portion according to the present invention is provided with a first display portion which includes an indication portion and a background portion, a second display portion which includes an indication portion and a background portion, a first light emitting portion for emitting a light with a first wavelength, and a second light emitting portion for emitting a light with a second wavelength which is different from the first wavelength. A difference of the light transmittance value with respect to the light with the first wavelength between the indication portion and the background portion of the first display portion is smaller than a difference of the light transmittance value with respect to the light with the first wavelength between the indication portion and the background portion of the second display portion. A difference of the light transmittance value with respect to the light with the second wavelength between the indication portion and the background portion of the second display portion is smaller than a difference of the light transmittance value with respect to the light with the second wavelength between the indication portion and the background portion of the first display portion.

Preferably, the light transmittance value with respect to the light with the first wavelength of the indication portion of the first display portion is substantially the same as that of the background portion of the first display portion. The light transmittance value with respect to the light with the second wavelength of the indication portion of the second display portion is substantially the same as that of the background portion of the second display portion.

Switching between the first and the second display portions of the light emitting display portion allows the respective display contents on the display portion to be observed through the reflective display portion with no interference.

In the structure, the reflectance value with respect to the light with a specific wavelength, and a hue observed upon application of an external light may be made different between the indication portion and the background portion of the reflective display portion. The light transmittance value with respect to the light with the wavelength emitted from the light emitting display portion of the indication portion of the reflective display portion may be made substantially the same as that of the background portion of the reflective display portion.

The device may be structured such that the reflectance value with respect to the light with a specific wavelength, and a hue observed upon application of an external light become different between the indication portion and the background portion of the reflective display portion, and the light transmittance value with respect to the light with the first wavelength is substantially the same as the transmittance value with respect to the light with the second wavelength between the indication portion and the background portion of the reflective display portion.

The display content may be observed from the reflective display portion as being colored, and the content on the light emitting display portion may be displayed with at least two types of hues.

The display device according to the present invention is provided with a first filter and a second filter which are laminated, and a first light source and a second light source each having a different center wavelength at a light emitting wavelength band. The first filter includes a first indication portion and a first background portion, and the second filter includes a second indication portion and a second background portion. A difference of a transmittance value of a light from the second light source between the first indication portion and the first background portion is larger than a difference of a transmittance value of the light from the second light source between the second indication portion and the second background portion. A difference of the transmittance value of the light from the first light source between the second indication portion and the second background portion is larger than the difference of the transmittance value of the light from the first light source between the first indication portion and the first background portion. A contrast between the second indication portion and the second background portion of the second filter is displayed upon transmission of the light from the first light source through the first filter and the second filter, and a contrast between the first indication portion and the first background portion of the first filter is displayed upon transmission of the light from the second light source through the first filter and the second filter.

The display device includes at least two light sources for emitting lights each with different wavelength. The totally different indication portions may be displayed dependent on the light from any of the two light sources as described above. The light emitting diodes for emitting lights with different hues may be provided so as to switch the display by executing easy circuit control for switching the light emitting diode for light emission.

For example, one of the first indication portion and the first background portion of the first filter is a colored portion which allows transmission of the light from the first light source to transmit, and the other is a non-colored portion which allows transmission of both the lights from the first and the second light sources. One of the second indication portion and the second background portion of the second filter is the colored portion which allows transmission of the light from the second light source, and the other is the non-colored portion which allows transmission of both the lights from the first and the second light sources.

The colored portion of the first filter has the same hue as that of the light emitted from the first light source. The colored portion of the second filter has the same hue as that of the light emitted from the second light source.

The first filter is positioned closer to the surface side than the second filter. The non-colored portion of the first filter is provided with the fluorescent layer which is excited by the light emitted from the second light source for emitting the light.

In the aforementioned case, preferably, the light emitted from the first light source transmits the colored portion and the fluorescent layer of the first filter with substantially the same transmittance.

In the present invention, the first indication portion and the second indication portion may be so disposed to be overlapped with each other.

Even if the first and the second indication portions are overlapped with each other, the light source may be switched to allow any one of the indication portions to be clearly displayed. Accordingly, the first and the second indication portions may be separately displayed without causing confusion therebetween.

A surface member which transmits the light is formed on each surface of the both filters, and a fixed display portion is provided for the surface member. The fixed display portion is observable in both cases where the light is applied from the first light source and the light is applied from the second light source.

The surface member allows the first and the second indication portions to be selectively displayed by switching the light source while having the fixed display portion kept ON.

Preferably, a half mirror layer for reflecting a part of the light and transmitting the other part of the light is provided between both the filters and the surface member.

The half mirror layer makes the color of the first or the second filter below the fixed display portion less-visible from the surface side when the light source is OFF.

When the light source for illumination which applies the light to the portion closer to the surface side than the half mirror layer is provided to illuminate the fixed display portion, the fixed display may be brightly executed. In the aforementioned case, the half mirror layer is likely to suppress the phenomenon which makes the hue of the first or the second filter seen owing to the light irradiated from the illumination light source.

The device is provided with the filter which has the indication portion and the background portion, a light source for irradiating the light which transmits the filter, and a surface member provided on the filter surface to allow transmission of the light. The transmittance of the light from the light source is different between the indication portion and the background portion of the filter. The display member includes the fixed display portion. The half mirror layer which reflects a part of the light, and transmits the other is disposed between the filter and the surface member.

In the aforementioned case, the illumination light source is disposed closer to the surface side than the half mirror layer for illuminating the fixed display portion.

Preferably, the reflective surface is used to partition the light path for the light which is emitted from the light source and transmits the filter from the light path for the light emitted from the illumination light source to reach the surface member.

Plural display contents may be clearly distinguished and displayed on the same position without causing interference thereamong. The plural types of the display and the plural hues may be selectively displayed clearly.

Switching between the first and the second indication portions is executed by selecting the light source to realize the display with the clear contrast. The light sources to be turned ON are made different to realize the plural types of the display with different hues. The first and the second indication portions may be distinguished and displayed on the same location.

Both the fixed display which is kept ON, and the display which is turned ON only when the power source is turned ON may be displayed adjacently.

### BRIEF DESCRIPTION OF THE DRAWINGS

FIG. 1 is a sectional view of an input portion provided with a display device according to a first embodiment of the present invention;

FIG. 2A is a plan view showing a display content on a reflective display portion;

FIG. 2B is a plan view showing the display content on a light emitting display portion;

FIG. 3 is a sectional view illustrating the structure of the display device according to the first embodiment;

FIG. 4 is a sectional view illustrating the structure of the display device according to a second embodiment;

FIG. 5 is a sectional view illustrating the structure of the display device according to a third embodiment;

FIG. 6 is a sectional view illustrating the structure of the display device according to a fourth embodiment;

FIG. 7 is a graph showing each wavelength band of blue, green, and red lights;

FIG. 8 is a plan view showing a display operation on the operation portion provided with the display devices according to a fifth embodiment of the present invention;

FIGS. 9A and 9B are plan views showing other display operations on the operation portion provided with the display devices according to the fifth embodiment of the present invention;

FIG. 10 is a sectional view of an operation mechanism shown in FIGS. 8 and 9;

FIG. 11 is a sectional view partially showing a component of the operation mechanism;

FIGS. 12A and 12B are explanatory views each showing a switching state of the display operation of the display device according to the fifth embodiment;

FIGS. 13A and 13B are explanatory views each showing a switching state of the display operation of the display device as a modified example of the fifth embodiment;

FIGS. 14A and 14B are explanatory views each showing a switching state of the display operation on the display device according to a sixth embodiment;

FIG. 15 is a sectional view showing an example having the display device combined with the input pad; and

FIG. 16 is a graph showing each wavelength band of blue, green and red lights, respectively.

### DESCRIPTION OF THE PREFERRED EMBODIMENTS

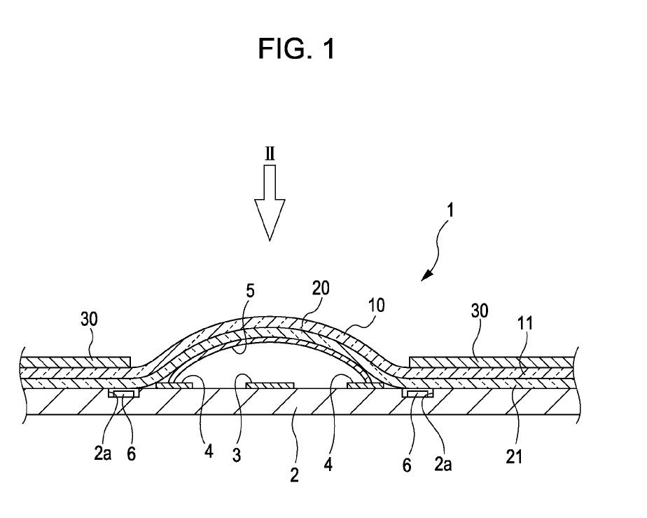

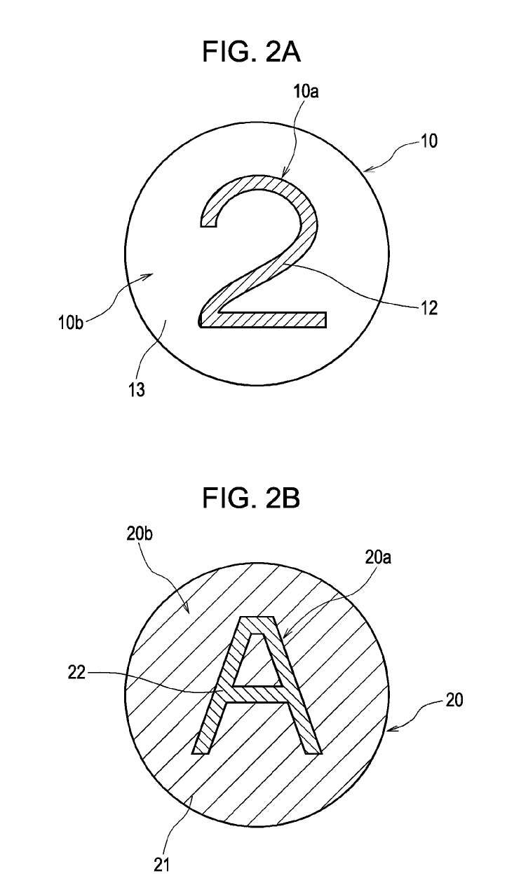

FIG. 1 is a sectional view showing the structure of a display device 1 according to a first embodiment of the present invention. FIGS. 2A and 2B are front views each showing an outer appearance of the display device 1 seen from an arrow II. FIG. 2A represents a display content of a reflective display portion, and FIG. 2B represents a display content of a light emitting display portion.

The display devices 1 shown in FIGS. 1, 2A and 2B are provided at plural locations on the operation surface of the small mobile electronic device such as a mobile phone. The display device 1 also serves as an input portion for inputting various operations.

The display device 1 includes a substrate 2, on which a switch mechanism is provided. The switch mechanism includes a center fixed contact 3 and peripheral fixed contacts 4 on the surface of the substrate 2. A movable contact 5 which is curved to form a dome-like shape is formed above the substrate 2. The movable contact 5 is formed of a conductive resilient plate member, and has a circumferential edge disposed on the peripheral fixed contact 4, and a center portion disposed opposite the center fixed contact 3 apart from each other. Being pressed toward the substrate 2, the movable contact 5 reversely deformed to have its center of the inner surface in contact with the center fixed contact 3. Then the center fixed contact 3 is made conductive to the peripheral fixed contacts 4.

A first resilient sheet 11 and a second resilient sheet 21 at the inner side thereof (closer to the substrate 2) are laminated on the surface of the substrate 2. Each of the first resilient sheet 11 and the second resilient sheet 12 is formed of the translucent resin sheet. The term “translucent” used herein denotes the feature for transmitting the light, and not necessarily limited to the feature for fully transmitting the externally applied light.

The second resilient sheet 21 and the first resilient sheet 11 are sequentially laminated and fixed onto the substrate 2 with the adhesive agent. The movable contact 5 is adhered and fixed to the inner surface of the second resilient sheet 21. This makes it possible to deflect the first and the second resilient sheets 11 and 21 accompanied with the reverse deformation of the movable contact 5 adhered thereto.

A light blocking layer 30 is formed on the first resilient sheet 11. The light blocking layer 30 is formed by coating the surface of the first resilient sheet 11, or formed by laminating the light blocking resin sheet on the first resilient sheet 11. The light blocking layer 30 is colored in black or the one with the other hue such that the transmittance becomes substantially 0%.

An input portion is provided with the switch mechanism having the movable contact 5. The input portion is provided with no light blocking layer 30 to form the single display device 1.

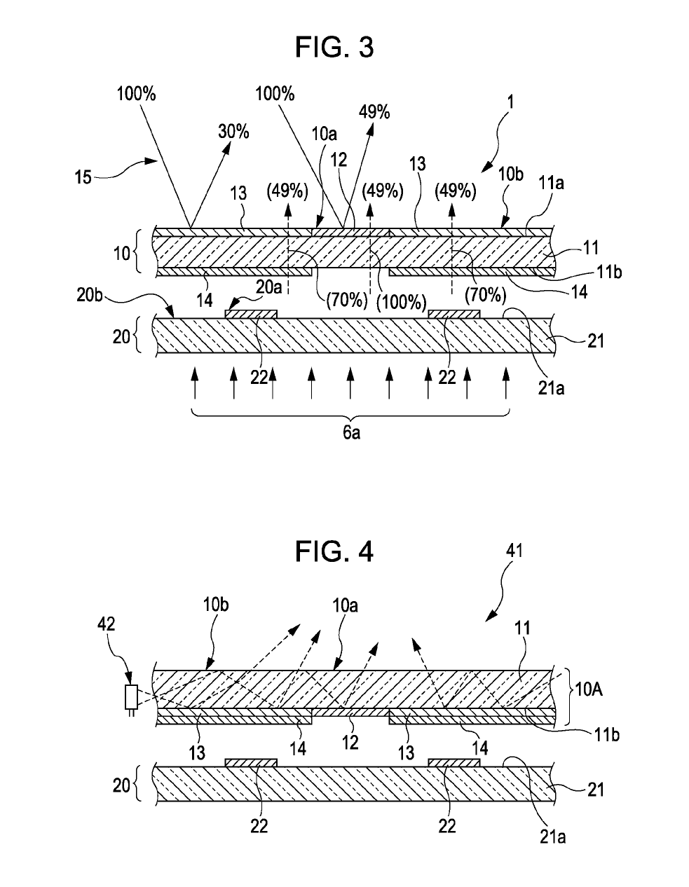

FIG. 3 is an enlarged sectional view showing the basic structure and the operation principle of the display device 1. The display device 1 is provided with a reflective display portion 10 which includes the first resilient sheet 11, and a light emitting display portion 20 located at the inner side (closer to the substrate 2) of the reflective display portion 10 and includes the second resilient sheet 21. FIG. 3 shows that the reflective display portion 10 and the light emitting display portion 20 are apart from each other. Actually however, the reflective display portion 10 and the light emitting display portion 20 are tightly laminated.

Referring to FIG. 1, recess portions 2a are formed at plural locations in the surface of the substrate 2 at each side of the peripheral fixed contacts 4. A light source 6 formed of a light emitting diode, for example, is mounted on each of the recess portions 2a. While the light source 6 is ON, the light emitted from the light source 6 is applied to the inside of the second resilient sheet 21 of the light emitting display portion 20 so as to be brought into the light emitting operation mode. FIG. 3 represents the operation of the light emitting display portion 20 assuming that a light 6a is applied to the second resilient sheet 21 from the inside (closer to the substrate 2) thereof.

The light emitting diode may be provided on the inner side of the second resilient sheet 21 for allowing the light emitting display portion 20 to emit light. The conductive layer for leading the light emitted from such light source as the light emitting diode to the light emitting display portion 20 may be provided further to the inner side of the second resilient sheet 21. Alternatively, a sheet-like light emitting layer such as an electroluminescence element may be provided to further the inner side of the second resilient sheet 21.

Referring to the reflective display portion 10 shown in FIG. 3, a first reflective layer 12 and a second reflective layer 13 are formed on an outer surface 11a of the first resilient sheet 11 at the outer side. FIG. 2A is a plan view of the reflective display portion 10 seen from outside. An indication portion 10a is defined by a region where the first reflective layer 12 is formed, and a background portion 10b is defined by a region where the second reflective layer 13 is formed. The indication portion 10a represents the character, graphic, code and other pattern. Referring to the example shown in FIG. 2A, the indication portion 10a represents the numerical pattern, and the background portion 10b is a region of the display device 1 other than the indication portion 10a. The indication portion 10a and the background portion 10b are representative of the regions each having different light reflectance upon application of the external light. The background portion 10b may be formed as the code or any other pattern. Alternatively, the indication portion 10a may be formed into the pattern which exhibits no particular meaning.

Referring to FIG. 3, when the external light 15 is applied to the outer surface 11a of the first resilient sheet 11, the first reflective layer 12 and the second reflective layer 13 have different reflectance values with respect to the external light 15. In the example shown in FIG. 3, the reflectance of the first reflective layer 12 to the external light 15 is 49%, and the reflectance of the second reflective layer 13 to the external light 15 is 30%. As the indication portion 10a formed of the first reflective layer 12 has the reflective light quantity to the external light 15 which is different from that of the background portion 10b formed of the second reflective layer 13, the indication portion 10a and the background portion 10b may be seen differently from each other while the light emitting display portion 20 is OFF. The operator is capable of reading the display of the number on the indication portion 10a of the display device 1 as shown in FIG. 2A.

Referring to FIG. 3, the inner surface 11b at the inner side of the first resilient sheet 11 has a light limiting layer 14 in the region corresponding to the background portion 10b. That is, the light limiting layer 14 is formed at the inner side of the second reflective layer 13 of the background portion 10b so as to be overlapped with the second reflective layer 13. The light limiting layer 14 is formed for compensating the light transmittance caused by the difference of the reflectance between the indication portion 10a and the background portion 10b. The use of the light limiting layer 14 allows the difference of the light transmittance between the indication portion 10a and the background portion 10b to be made smaller than the reflectance difference therebetween.

In the example shown in FIG. 3, the light transmittance of the light limiting layer 14 to the light applied from the light emitting display portion 20 is 70%. On the background portion 10b, the light applied from the light emitting display portion 20 to the reflective display portion 10 is limited by the light limiting layer 14 such that 70% of the light quantity is applied to the first resilient sheet 11. The light quantity corresponding to 30% of the applied light is reflected on the second reflective layer 13. So the background portion 10b is capable of transmitting 49% of the light that can be applied from the light emitting display portion 20 outward. Meanwhile, the indication portion 10a irradiates substantially 100% of the light quantity from the light emitting display portion 20 to the first resilient sheet 11, and 49% of the incident light is reflected on the first reflective layer 12. Accordingly, 49% of the light quantity transmits the first reflective layer 12 to advance outward.

Preferably, an anti-reflective film is formed on the inner surface 11b of the first resilient sheet 11 of the indication portion 10a for the purpose of allowing substantially 100% of the light applied from the light emitting display portion 20 to be irradiated to the inside of the first resilient sheet 11.

Each of the indication portion 10a and the background portion 10b of the reflective display portion 10 has the same transmittance of the light applied from the light emitting display portion 20.

Referring to the light emitting display portion 20 as shown in FIG. 3, a display layer 22 is formed on an outer surface 21a of the second resilient sheet 21 opposite the reflective display portion 10. Referring to FIG. 2B, the region on which the display layer 22 is formed is the indication portion 20a, and the region on which the display layer 22 is not formed is the background portion 20b. The display layer 22 limits the light transmittance, or controls the wavelength of the transmitting light, which is formed as a color filter layer with the predetermined hue other than white and black. The display layer 22 may be the light blocking layer which prevents transmission of substantially all the light. The background portion 20b may be the one to which the light transmitting the second resilient sheet 21 is directly irradiated. The color filter which transmits the light with the predetermined waveform may be formed on the outer surface 21a of the second resilient sheet 21 on the background portion 20b. In the aforementioned case, it is preferable to change the hue of the color filter formed on the indication portion 20a to be different from that of the color filter formed on the background portion 20b such that transmitting waveform of the light becomes different.

The indication portion 20a of the light emitting display portion 20 represents the predetermined character, graphic, code or pattern to be displayed, which are different from those on the indication portion 10a of the reflective display portion 10. In the example shown in FIG. 2B, the Roman character is displayed on the indication portion 20a.

With the display device 1, when the light emitting display portion 20 is not activated by keeping the light source 6 OFF, the external light 15 is reflected on the reflective display portion 10. Then the numerical display on the indication portion 10a is visible as shown in FIG. 2A because of the difference of the light reflectance between the indication portion 10a and the background portion 10b. When the light 6a is applied to the light emitting display portion 20 by turning the light source 6a ON, the light emitted from the light emitting display portion 20 advances outside while keeping the same light transmittance both at the indication portion 10a and the background portion 10b of the reflective display portion 10. As a result, the contrast between the indication portion 20a and the background portion 20b of the light emitting display portion 20 is visible from outside as shown in FIG. 2B. At this time, each value of the light transmittance of the indication portion 10a and the background portion 10b of the reflective display portion 10 is the same, and accordingly, it is substantially impossible to distinguish the indication portion 10a from the background portion 10b of the reflective display portion 10 shown in FIG. 2A.

The display shown in FIG. 2A may be visually distinguished from the display shown in FIG. 2B clearly between the case where the light source 6 is turned OFF and the case where the light source 6 is turned ON.

Preferably, the difference of the reflectance between the indication portion 10a and the background portion 10b does not exceed 50%. This makes it possible to reduce the light quantity of the light source 6 required for interfering with the visual distinguished between the indication portion 10a and the background portion 10b of the reflective display portion 10 even if the intense external light is applied.

Each of the first resilient sheet 11 and the second resilient sheet 21 is formed of the transparent resin sheet such as PMMA (polymethylmethacrylate), PET (polyethylene terephthalate), and acryl. Alternatively, the rigid and non-resilient transmitting plate with the translucency may be employed instead of using the first and the second resilient sheets 11 and 12.

Each of the first and the second reflective layers 12 and 13 serves as the film for forming the so-called half mirror, which is formed of the metal film such as Al, Ag, Cr, and Au, or the non-metal film such as ZnS, CeO2, and TiO2. The metal film or the non-metal film is formed on the outer surface 11a of the first resilient sheet 11 through the deposition process. In the process of the formation, each light reflectance of the films may be made different by changing the thickness, density or the type of the film.

The light limiting layer 14 partially transmits the light applied from the light emitting display portion 20. For example, the light limiting layer 14 as a light absorbing layer which partially absorbs the optical energy inside is structured as a light absorbing filter formed as a multi-laminated layers of the metal film or the non-metal film while changing the product of the refraction index (n) and the depth (d), that is (n×d), the light absorbing filter formed of the dielectric film, and the light absorbing filter having the black filler such as carbon dispersed in the binder resin with the appropriate density. Alternatively, the light limiting layer 14 may be the reflective film for transmitting the light by a predetermined ratio (for example, 60%), and reflecting the rest of the light (for example, 40%). If the light limiting layer 14 is the reflective film, the diffuse reflection may repeatedly occur between the light limiting layer 14 and the second reflective layer 13. So it is preferable to form the light limiting layer 14 as the light absorbing layer.

The display layer 22 is formed of the color filter which reflects the light with the predetermined wavelength, and transmits the light with the predetermined wavelength as described above. Alternatively, the display layer 22 may be the fluorescent layer which is excited by the light with the predetermined wavelength applied from the light source 6.

The display device 1 shown in FIG. 1 is provided with the switch mechanism including the fixed contacts 3, 4 and the movable contact 5 below the reflective display portion 10 and the light emitting display portion 20. However, an input pad of capacitance type may be disposed below the light emitting display portion 20. The input pad of capacitance type includes plural X-electrodes and plural Y-electrodes having an insulating layer interposed therebetween. The plural X-electrodes and Y-electrodes are sequentially selected to receive the pulse voltage. The input pad is covered with the light emitting display portion 20 and the reflective display portion 10. When the grounded conductive body such as a finger touches the surface of the reflective display portion 10, the capacitance between the X- or Y-electrode and the finger is added to the capacitance between the X-electrode and Y-electrode. The capacitance between the X-electrode and the Y-electrode at the position touched by the finger is changed. The detection with respect to the electrode which receives application of the voltage to decrease rise-up of the voltage between the electrodes allows the position touched by the finger to be located.

When the input pad of capacitance type is employed, it is essential to use the first reflective layer 12 and the second reflective layer 13 each formed of the non-conductive material. The first reflective layer 12 or the second reflective layer 13 is needed to be structured as the non-conductive reflective film having the metal film with the discontinuous plane and no electrically-conducting path.

FIG. 4 and subsequent drawings show other embodiments of the present invention. In the embodiments, the same structure as that of the first embodiment shown in FIG. 3 will be designated with the same code, and a detailed explanation thereof, thus will be omitted.

FIG. 4 is a sectional view of a display device 41 according to a second embodiment. The display device 41 has the light emitting display portion 20 with the same structure as that of the display device 1 shown in FIG. 3. In the display device 41 shown in FIG. 4, a reflective display portion 10A is laminated on the outer side of the light emitting display portion 20. In the reflective display portion 10A, the first reflective layer 12 and the second reflective layer 13 are formed on an inner surface 11b of the translucent first resilient sheet 11. The light limiting layer 14 is further laminated at the inner side of the second reflective layer 13. In the reflective display portion 10A, the region on which the first reflective layer 12 is formed is the indication portion 10a shown in FIG. 2A, and the region on which the second reflective layer 13 and the light limiting layer 14 are laminated is the background portion 10b shown in FIG. 2A.

In the display device 41, the first resilient sheet 11 of the reflective display portion 10A may be employed as the illumination layer at the surface side. For example, the first resilient sheet 11 is directed opposite the light source 42 for irradiating the light thereto, that is, the illumination unit so as to illuminate the first reflective layer 12 and the second reflective layer 13 brightly by the light propagating in the first resilient sheet 11.

The respective reflectance values of the indication portion 10a and the background portion 10b of the reflective display portion 10A are largely different with respect to the external light as well as the reflectance values with respect to the illuminating light applied from the light source 42 to the inside of the first resilient sheet 11. This makes it possible to visually distinguish the indication portion 10a from the background portion 10b. When the light source 42 is turned OFF to activate the light emitting display portion 20, the light emitted therefrom transmits both the indication portion 10a and the background portion 10b at the same light transmittance. This makes it possible to visually identify the indication portion 20a and the background portion 20b of the light emitting display portion 20 clearly as shown in FIG. 2B.

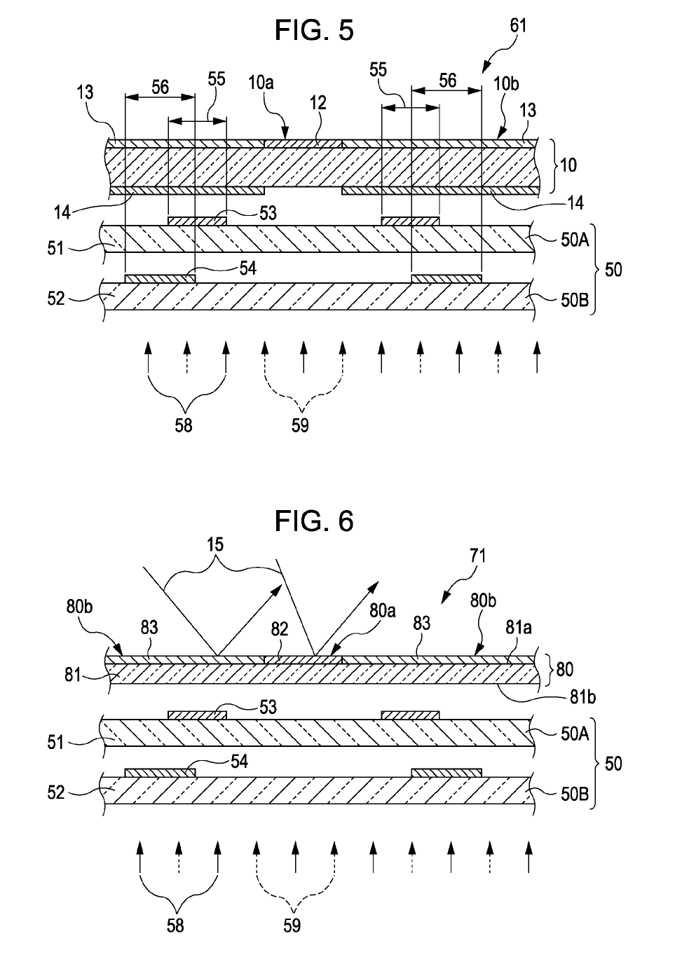

FIG. 5 is a sectional view of a display device 61 according to a third embodiment of the present invention. The display device 61 has the reflective display portion 10 with the same structure as that of the display device 1 according to the first embodiment shown in FIG. 3. Alternatively, the reflective display portion 10A with the same structure as shown in FIG. 4 may be employed.

A light emitting display portion 50 is formed by laminating a first translucent sheet 51 and a second translucent sheet 52. Referring to FIG. 5, the reflective display portion 10, the first translucent sheet 51 and the second translucent sheet 52 are apart from one another. Actually, however, they are laminated in tight contact with one another.

A first color filter 53 is formed on the outer surface of the first translucent sheet 51. A first display portion 50A is formed of the first translucent sheet 51 and the first color filter 53. The region of the first display portion 50A, on which the first color filter 53 is formed is an indication portion 55, and the region except the indication portion 55 is a background portion. A second color filter 54 is formed on the outer surface of the second translucent sheet 52. A second display portion 50B is formed of the second translucent sheet 52 and the second color filter 54. The region of the second display portion 50B, on which the second color filter 54 is formed is an indication portion 56, and the region except the indication portion 56 is a background portion.

The light emitting display portion 50 selectively receives application of light 58 with a first wavelength from a first light emitting portion disposed inside, and light 59 with a second wavelength from a second light emitting portion. The light 58 with the first wavelength and the light 59 with the second wavelength may be selectively applied to the inside of the second translucent sheet 52.

The difference of the light transmittance with respect to the light 58 with the first wavelength between the first translucent sheet 51 and the first color filter 53 is smaller than the difference of the light transmittance between the second translucent sheet 52 and the second color filter 54. That is, the difference of the light transmittance with respect to the light 58 with the first wavelength between the indication portion 55 and the background portion of the first display portion 50A is smaller than the difference of the transmittance between the indication portion 56 and the background portion of the second display portion 50B.

The difference of the light transmittance with respect to the light 59 with the second wavelength between the second translucent sheet 52 and the second color filter 54 is smaller than the difference of the light transmittance between the first translucent sheet 51 and the first color filter 53. That is, the difference of the light transmittance with respect to the light 59 with the second wavelength between the indication portion 56 and the background portion of the second display portion 50B is smaller than the difference of the transmittance between the indication portion 55 and the background portion of the first display portion 50A.

In the embodiment shown in FIG. 5, the light 58 with the first wavelength is red, and the first color filter 53 reflects and transmits the light with red wavelength. That is, the first color filter 53 is the red color filter. The light 59 with the second wavelength is blue, and the second color filter 54 reflects and transmits the light with blue wavelength. That is, the second color filter 54 is the blue color filter.

There is substantially no difference of the light transmittance with respect to the lights with the red and blue wavelengths between the indication portion 10a and the background portion 10b of the reflective display portion 10.

When the light source of the light 58 with the first wavelength and the light 59 with the second wavelength is turned OFF, the external light is reflected on the indication portion 10a and the background portion 10b of the reflective display portion 10 in the display device 61 shown in FIG. 5 at different reflectance values, respectively. This allows the user to visually distinguish the indication portion 10a from the background portion 10b as shown in FIG. 2A.

When the first light emitting portion is activated to apply the light 58 with the first wavelength as the red light to the light emitting display portion 50, the red light is mixed with the blue light of the second color filter 54 to make the indication portion 56 of the second display portion dark. The light 58 with the first wavelength as the red light is allowed to transmit the second translucent sheet 52, the first translucent sheet 51, and the red first color filter 53 each at substantially the same transmittance. The dark light and the red light transmit the indication portion 10a and the background portion 10b of the reflective display portion 10 each at substantially the same transmittance. The indication portion 56 appears dark, and the background portion as the other portion is displayed in red.

When the second light emitting portion is activated to apply the light 59 with the second wavelength as blue light to the light emitting display portion 50, the blue light is mixed with the red light of the first color filter 53 to make the indication portion 55 of the first display portion dark. The light 59 with the second wavelength as the blue light is allowed to transmit the second translucent sheet 52, the blue second color filter 54, and the first translucent sheet 51 each at substantially the same transmittance. The dark light and the blue light as described above transmit the indication portion 10a and the background portion 10b of the reflective display portion 10 each at substantially the same transmittance. The indication portion 55 appears dark, and the background portion as the other portion is displayed in blue.

When the light emitting display portion 50 is not activated, the display content of the reflective display portion 10 is visible. Two different patterns may be displayed on the light emitting display portion 50 depending on cases where the light 58 with the first wavelength is applied, and the light 59 with the second wavelength is applied. Each of the two display patterns is visible through the reflective display portion 10.

FIG. 6 is a sectional view of a display device 71 according to a fourth embodiment of the present invention. The display device 71 has the light emitting display portion 50 with the same structure as that of the display device 41 shown in FIG. 4.

A reflective display portion 80 laminated on the outer side of the light emitting display portion 50 has a translucent first resilient sheet 81. A first reflective layer (first filter) 82 and a second reflective layer (second filter) 83 are formed on an outer surface 81a of the first resilient sheet 81. Each of the first and the second reflective layers 82 and 83 is formed as a color filter which is capable of reflecting or transmitting the lights each at the different wavelength band, and is not capable of reflecting and transmitting the light at the other wavelength band. The region on which the first reflective layer 82 is formed is an indication portion 80a, and the region on which the second reflective layer 83 is formed is a background portion 80b.

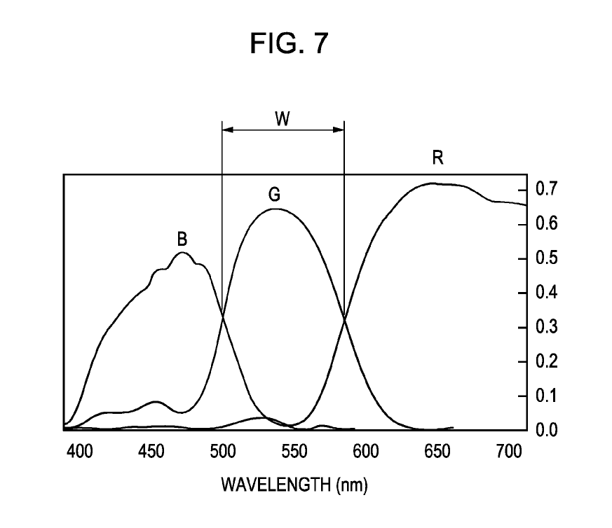

FIG. 7 shows the relationship between each wavelength of blue (B) light, green (G) light and red (R) light, and the intensity. Any one of the first reflective layer (first filter) 82 and the second reflective layer (second filter) 83 is a bandpass filter which reflects and transmits the light at the wavelength band W shown in FIG. 7. The bandpass filter is green, and transmits both the red light and the blue light with substantially the same transmittance. The other of the first reflective layer (first filter) 82 and the second reflective layer (second filter) 83 is a filter in color other than green, for example, gray, and exhibits the transmittance with respect to the red and blue lights, which is substantially the same as that of the filter for transmitting the light at the wavelength band W.

In the display device 71 shown in FIG. 6, when the light 58 with the first wavelength and the light 59 with the second wavelength are not generated, the external light 15 allows any one of the indication portion 80a and the background portion 80b to be displayed in green, and the other to be displayed in gray. This allows the user to recognize the display content of the indication portion 80a.

When the light 58 with the first wavelength as the red light is applied, the indication portion 56 appears dark, and the background portion appears red when seen from outside because the light with the red wavelength is allowed to transmit the indication portion 80a and the background portion 80b of the reflective display portion 80 with substantially the same transmittance. When the light 59 with the second wavelength as the blue light is applied, the indication portion 55 appears dark, and the background portion appears blue when seen from outside because the light with the blue wavelength is allowed to transmit the indication portion 80a and the background portion 80b of the reflective display portion 80 with substantially the same transmittance.

The first reflective layer 82 and the second reflective layer 83 of the reflective display portion 80 may be formed on the inner surface 81b of the first resilient sheet 81, and the illumination unit for applying the light to the inside of the first resilient sheet 81 may be provided. In the aforementioned case, the light is applied to the inside of the first resilient sheet 81 without applying the light 58 with the first wavelength and the light 59 with the second wavelength to indicate the difference of the hue between the indication portion 80a and the background portion 80b of the reflective display portion 80 brightly through the illumination.

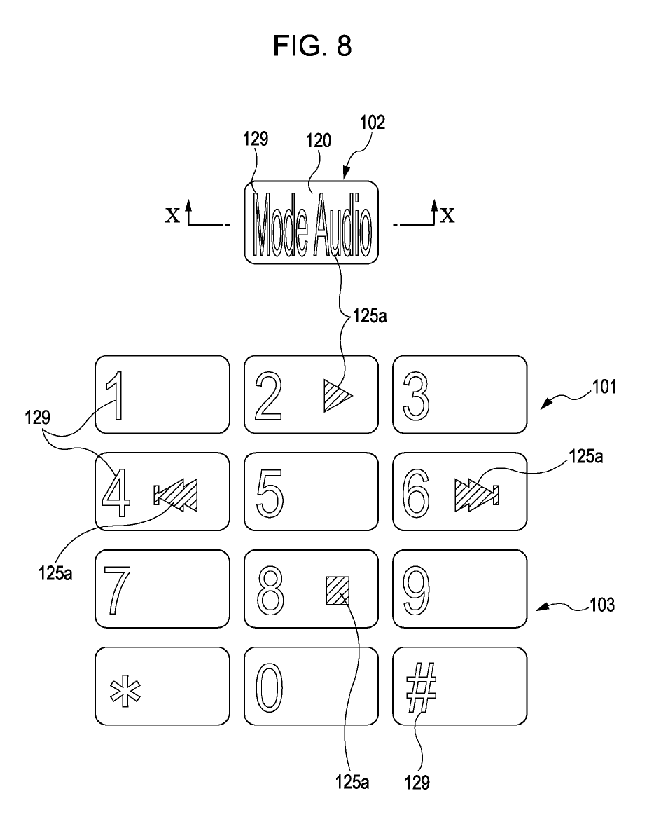

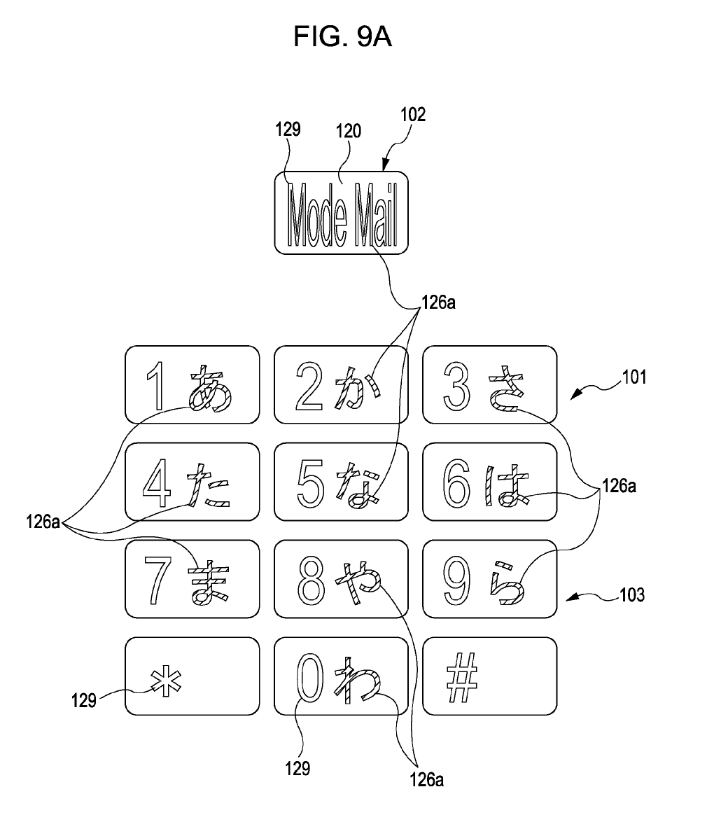

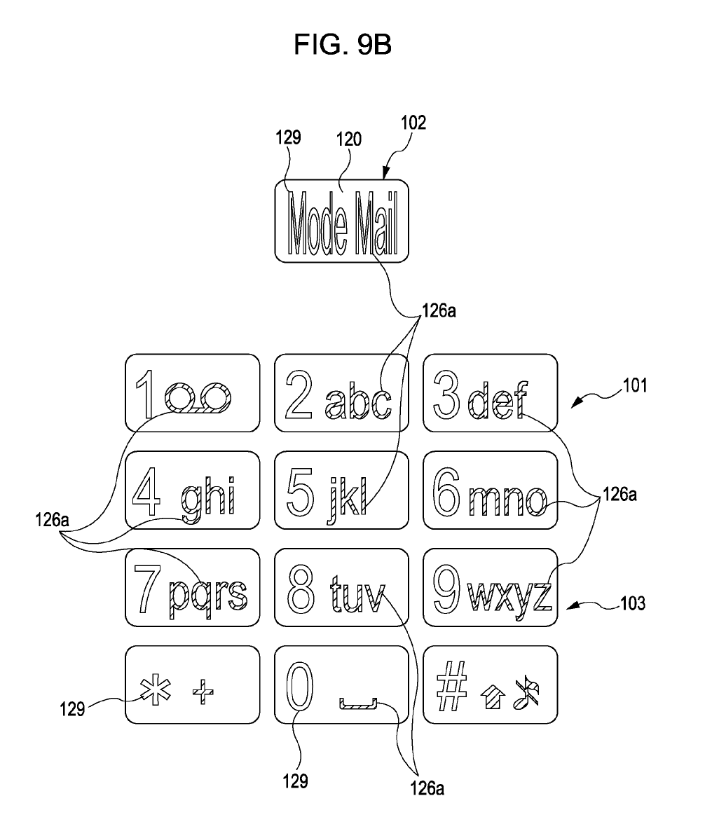

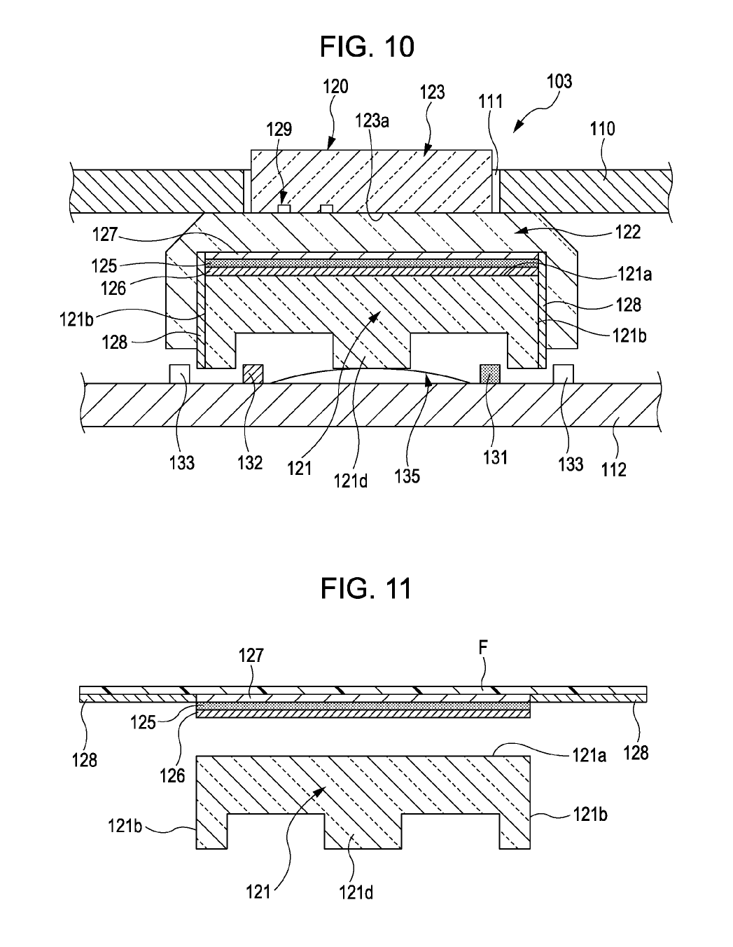

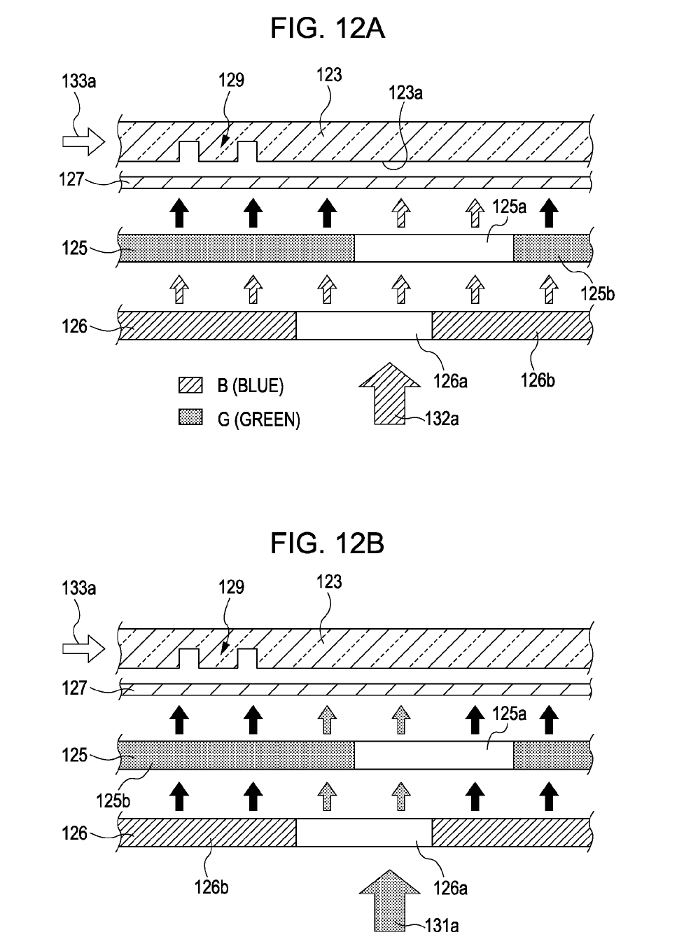

FIGS. 8, 9A and 9B are plan views each showing the operation portion of the mobile device which employs the display device according to the fifth embodiment of the present invention in a different display mode. FIG. 10 is a partially sectional view of a part of the operation mechanism of the operation portion shown in FIGS. 8, 9A and 9B taken along line X-X of FIG. 8. FIG. 11 is a sectional view showing a structure of the component of the operation mechanism. FIGS. 12A and 12B are explanatory views each showing a switching operation of the display on the operation portion according to the fifth embodiment.

FIGS. 8, 9A and 9B are plan views each showing an operation portion 101 of the mobile device such as a mobile phone. The operation portion 101 includes a relatively large operation mechanism 102 at the upper side, and 12 operation mechanisms 103 in 4×3 arrangement at the lower side. The operation mechanisms 102 and 103 may be operated through depression, each provided with a display device for displaying the operation indication on the surface.

Referring to FIGS. 8, 9A and 9B, the display of “Mode” on the operation mechanism 102, and display of “0, 1, 2, 3, . . . *, #” on the respective operation mechanisms 103 are of fixed type to be constantly displayed irrespective of switching operation of the light source.

Switching between a first light source 131 and a second light source 132 may change the illumination display of the operation mechanisms 102 and 103, respectively. Referring to FIG. 8, when selecting the second light source 132 for illumination, the “Audio” on the operation mechanism 102 and an “arrow-shaped” first indication portion are displayed. Referring to FIG. 9A, when selecting the first light source 131 for illumination, the display of the first indication portion is disappeared, and the “Mail” and KANA characters as the second indication portion are displayed. As FIG. 9B shows, alphabetical letters may be displayed instead of KANA characters.

FIG. 10 is a longitudinal sectional view of the operation mechanism 102. The dimension of the operation mechanism 102 is different from each dimension of the operation mechanisms 103 as illustrated in the plan view shown in FIGS. 8, 9A and 9B. However, they have basically the same structures.

FIG. 10 shows the cross-section of the synthetic resin panel 110 of the mobile device. The panel 110 of the operation mechanism 103 has a through hole 111 with a square shape which accommodates a push button 120 so as to be arbitrarily depressed.

The push button 120 includes an inner member 121, an outer member 122 and a surface member 123. Each of those three members is formed of a translucent synthetic resin material such as PMMA (polymethymethacrylate) resin and PC (polycarbonate) resin as the clear and colorless material. The inner portion may be slightly colored or colored in opaque white so long as the color illumination display on the first and the second indication portions shown in FIGS. 8 and 9 are not interfered. Those three members may be formed of the transparent elastomer resin materials so as to be deformable by the external force.

Referring to FIG. 11, the inner member 121 has an upper surface 121a, on which a second filter 126, a first filter 125 and a half mirror layer 127 are sequentially laminated from the lower side. A mirror layer 128 is provided over the entire circumference of a side surface 121b of the inner member 121.

FIG. 11 shows an example of the method for forming the second filter 126, the first filter 125, and the half mirror layer 127 on the upper surface of the inner member 121, and forming the mirror layer on the side surface 121b. In the example, the half mirror layer 127, the first filter 125, and the second filter 126 are laminated on the resin film F such as the PET sequentially from the film surface in the printing step. The mirror layer 128 is laminated on the surface of the resin film F at both sides in the printing step. After drying the respective layers formed in the printing step, the resin film F is placed on the inner surface of a mold for the injection molding, and the transparent resin is injected into the mold to form the inner member 121. After the resin is cured, the inner member 121 is taken from the mold, and the resin film F is removed such that the respective layers are transferred onto the upper surface 121a and the side surfaces 121b of the inner member 121.

FIGS. 12A and 12B are enlarged views each showing the first filter 125, the second filter 126 and the half mirror layer 127, respectively.

The first filter 125 includes a first indication portion 125a and a first background portion 125b. Referring to FIG. 8, the first indication portion 125a allows the “Audio” to be displayed on the operation mechanism 102. The first indication portion 125a allows such mark as the “arrow” to be displayed on the respective operation mechanisms 103. The background portion 125b is colored with green hue. That is, the first filter 125 is formed by printing in the transparent binder resin with a green ink which contains the green pigment. In the printing process, the non-colored region which blocks adhesion of the ink layer is formed. The non-colored region becomes the first indication portion 125a. The first indication portion 125a may be formed of the transparent resin layer which contains no pigment.

The second filter 126 includes a second indication portion 126a and a second background portion 126b. Referring to FIGS. 9A and 9B, the second indication portion 126a allows the “Mail” to be displayed on the operation mechanism 102. The second indication portion 126a allows the KANA or Roman characters to be displayed on the respective operation mechanisms 103. The second background portion 126b is colored with blue hue. That is, the second filter 126 is formed by printing in the transparent binder resin with a blue ink which contains the blue pigment. The non-colored region which blocks adhesion of the ink in the printing process becomes the second indication portion 126a. The second indication portion 126a may be formed of the transparent resin layer which contains no pigment.

The first indication portion 125a of the first filter 125 and the second indication portion 126a of the second filter 126 are overlapped with each other at the same location.

FIG. 16 is a graph showing the wavelength bands of three primary colors of blue (B), green (G) and red (R), and the intensity of the light. The background portion 125b of the first filter 125 allows transmission of only the light at the wavelength band WG as shown in FIG. 16, in other words, only the green light, and substantially no blue light. The second background portion 126b of the second filter 126 allows transmission of only the light at the wavelength band WG as shown in FIG. 16, in other words, only the blue light, and substantially no green light. The first indication portion 125a of the first filter 125 and the second indication portion 126a of the second filter 126 allow transmission of all the visible lights.

Referring to FIG. 10, a substrate 112 is provided inward of the panel 110. A first light source 131 and a second light source 132 are formed on the surface of the substrate 112. Both the first light source 131 and the second light source 132 are light emitting units each containing the light emitting diode. The color of the light with the first wavelength emitted from the first light source is green, and the color of the light with the second wavelength emitted from the second light source is blue.

Referring to FIGS. 12A and 12B, the first background portion 125b of the first filter 125 allows transmission of the light from the first light source 131, and does not allow transmission of the light from the second light source 132. The background portion 126b of the second filter 126 allows transmission of the light from the second light source, and does not allow transmission of the light from the first light source 131.

The transmittance value of the first background portion 125b with respect to the green light 131a from the first light source 131 is higher than the transmittance value with respect to a blue light 132a from the second light source 132. The transmittance value of the second background portion 126b with respect to the blue light 132a from the second light source 132 is higher than the transmittance value with respect to the green light 131a from the first light source 131.

The difference of the transmittance value with respect to the light 132a from the second light source 132 between the first indication portion 125a and the first background portion 125b is larger than the difference of the transmittance value with respect to the light 132a from the second light source 132 between the second indication portion 126a and the second background portion 126b. The difference of the transmittance value with respect to the light 131a from the first light source 131 between the second indication portion 126a and the second background portion 126b is larger than the difference of the transmittance value with respect to the light 131a from the first light source 131 between the first indication portion 125a and the first background portion 125b.

Each of the half mirror layer 127 and the mirror layer 128 is formed of the ink as the transparent binder resin which contains the metal filler such as Al, Ag, Cr, and Au, or the non-metal filler such as ZnS, CeO2, and TiO2. The content of the filler and the film thickness of the half mirror layer 27 are set so as to reflect a part of the white light and to allow transmission thereof. Meanwhile, the content of the filler and the film thickness of the mirror layer 128 are set so as to reflect substantially all the white light. Each of the half mirror layer 127 and the mirror layer 128 may be formed of the deposited film of Al, Ag, Cr, Au, or ZnS, CeO2, TiO2 and have the thickness changed to be formed as the half mirror or the total reflection mirror.

It is preferable to use the total reflection mirror as the mirror layer 128. However, it may be the half mirror film continued to the half mirror layer 127 so long as the reflectance value is high.

Referring to FIG. 10, a fixed display portion 129 is provided at the boundary between the outer member 122 and the surface member 123. The fixed display portion 129 is defined by forming the lower surface 123a of the surface member 123 into a recess portion. As described above, the fixed display portion 129 allows the “Mode” to be displayed on the operation mechanism 102, and the “0, 1, 2, 3 . . . 8, #” to be displayed on the operation mechanisms 103.

Referring to FIG. 10, illumination light sources 133, 133 are provided on the surface of the substrate 112 opposite the lower ends of the outer member 122. The illumination light sources 133, 133 are light emitting diodes for emitting the white light. Alternatively, the illumination light source 133 may be the light emitting diode for emitting the light with the hue different from that of the light from the first light source 131 and the second light source 132. The light emitted from the illumination light sources 133, 133 is applied to the inside of the outer member 122. However, the mirror layer 128 suppresses incidence of the light to the inside of the inner member 121. Specifically, the mirror layer 128 serves as a partition to separate the optical path of the light emitted from the first and the second light sources 131 and 132, and the optical path of the light emitted from the illumination light sources 133, 133.

A protruding pressing portion 121d is integrally formed with the center of the inner member 121 at the lower end. A switch mechanism 135 is provided on the surface of the substrate 112, which is pressed by the pressing portion 121d and activated upon depression of the push button 120. The switch mechanism 135 includes a metal dome member and an electrode layer formed on the surface of the substrate 112. When the dome member is pressed and reversely deformed by the pressing portion 121d, it is brought into contact with the electrode layer to close the circuit.

An operation for switching the display content on the display device of the operation mechanism 103 will be described. FIGS. 12A and 12B schematically show how the light transmits the first filter 125, the second filter 126, the half mirror layer 127, and the surface member 123.

FIG. 12A shows the operation of the device in the case where the first light source 131 is turned OFF and the second light source 132 is turned ON so as to be brought into the display state shown in FIG. 8. FIG. 12B shows the operation of the device in the case where the first light source 131 is turned ON, and the second light source 132 is turned OFF so as to be brought into the display state shown in FIG. 9. FIGS. 12A and 12B show arrows corresponding to the green light 131a emitted from the first light source 131, the blue light 132a emitted from the second light source 132, and a light 133a emitted from the illumination light source 133, respectively.

The fixed display portion 129 as the recess portion formed in the lower surface 123a of the surface member 123 may be visually identified constantly from the front of the surface member 123 due to reflection of the light therein. When the illumination light source 133 is OFF, the external light is irradiated into the surface member 123 and the outer member 122, and partially reflected by the half mirror layer 127. So the fixed display portion 129 may be visually recognized.

When the illumination light source 133 is turned ON, the emitted light 133a is led from the outer member 122 to the surface member 123. Such light is diffusely reflected by the fixed display portion 129 so as to be brightly displayed to the front of the surface member 123.

The light 133a led into the outer member 122 is blocked by the mirror layer 128 so as not to further advance inward from the side surface 121b of the inner member 121. The half mirror layer 127 formed on the first filter 125 may prevent incidence of the light 133a emitted from the illumination light source 133 led into the outer member 122 into the first filter 125.

When the first and the second light sources 131 and 132 are turned OFF, displays of the first indication portion 125a and the second indication portion 126a are hardly seen from the front of the surface member 123 even if the illumination light source 133 is ON. The fixed display portion 129 may only be clearly observed.

Referring to FIG. 12A, upon emission from the second light source 132, the blue light 132a transmits the second background portion 126b of the second filter 126 which is blue as well, and further transmits the second indication portion 126a. The light which has transmitted the second filter 126 is blue in all the regions. The blue light transmits the first indication portion 125a of the first filter 125 above the second filter 126, and further transmits the half mirror layer 127 so as to be applied to the surface member 123. The first background portion 125b of the first filter 125 hardly transmits the blue light because of narrow band WG of the transmission wavelength as shown in FIG. 16. The first background portion 125b appears dark when seen from the front of the surface member 123.

Referring to FIG. 8, the fixed display portion 129 on the surface of the push button 120 can be seen, and the first indication portion 125a is brightly displayed in blue by the side of the fixed display portion 129. The first background portion 125b is oppositely disposed at the inner side of the fixed display portion 129. Accordingly, the fixed display portion 129 and the portion as the background of the first indication portion 125a appear dark in substantially black. At this time, the fixed display portion 129 may be visually identified as the half mirror layer 127 reflects the external light without turning the illumination light source 1330N. If the illumination light source 133 is ON, the fixed display portion 129 may be brightly illuminated. This makes it possible for the user to see both the brightly illuminated fixed display portion 129 and the first indication portion 125a simultaneously.

Referring to FIG. 12B, when the green light 131a is applied from the first light source 131, the light 131a transmits the second indication portion 126a of the second filter 126. As shown in FIG. 16, the second background portion 126b of the second filter 126 hardly transmits the green light 131a because of the narrow wavelength band WB of the light which transmits the second background portion 126b of the second filter 126. Then the light 131a from the first light source 131 is allowed to transmit only the second indication portion 126a. The first indication portion 125a and the first background portion 125b of the first filter 125 allow transmission of the green light 131a.

Referring to FIGS. 9A and 9B, the use of the push button 120 allows the second indication portion 126a by the side of the fixed display portion 129 to be brightly illuminated in green. As the second background portion 126b is oppositely provided on the back side of the fixed display portion 129, the background other than the fixed display portion 129 and the second indication portion 126a appears dark in substantially black. The fixed display portion 129 may be brightly illuminated on the dark background by turning the illumination light source 1330N.

As described above, the different contents in different colors, for example, “Audio” and “Mail” may be separately displayed at the same location by selectively turning the first light source 131 and the second light source 1320N. As the background is displayed dark, the aforementioned display content and the fixed display portion 29 may be clearly displayed.

In the embodiment, the print layer is formed by laminating the first filter 125 and the second filter 126. A colored layer formed on the surface of the transparent film only at the background portion may be employed as the first and the second filters 125 and 126. Alternatively, a colored layer for forming the first background portion 125b is formed on one surface of the single film, and the colored layer for forming the second background portion 126b is formed on the other surface such that the first filter 125 and the second filter 126 are formed from the single film.

The fixed display portion 129 may be formed by printing the lower surface 123a of the surface member 123 with the ink of a predetermined color. Alternatively, an opaque white resin layer or the fluorescent layer may be buried inside the recess portion for forming the fixed display portion 129.

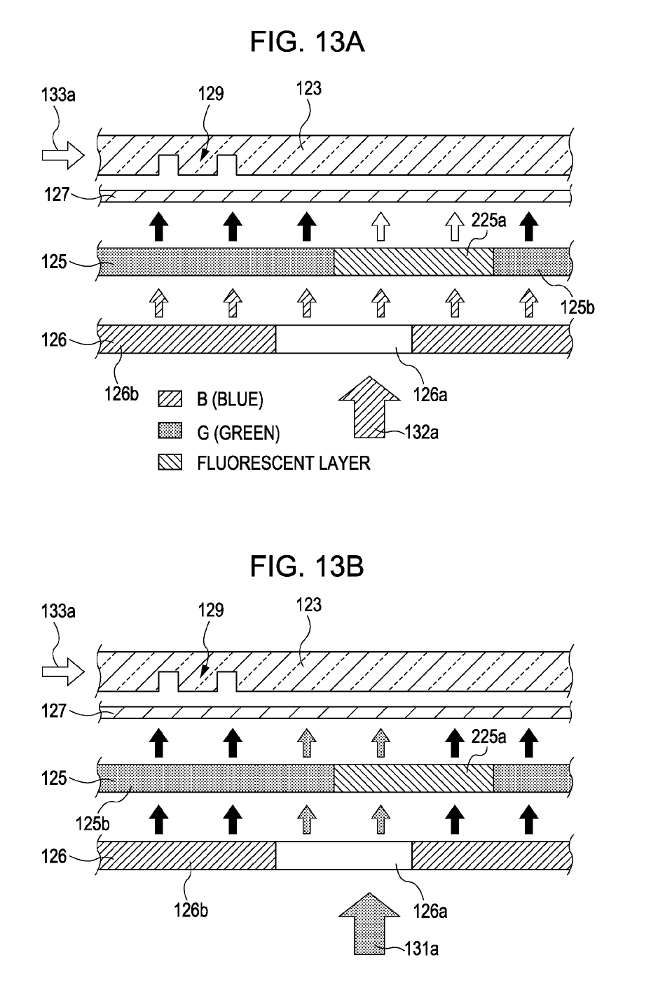

FIGS. 13A and 13B illustrate a modified example of the display device according to the fifth embodiment. The example in FIGS. 13A and 13B is substantially the same as the one shown in FIGS. 12A and 12B except that the first indication portion 225a of the first filter 125 is the fluorescent layer.

When the blue light is applied, the fluorescent layer for forming the first indication portion 225a is excited to emit the white light. The fluorescent layer is not excited by the light in the color other than blue, which transmits the light in color other than blue at substantially the same transmittance as that of the first background portion 125b.

In the method of manufacturing the first filter 125, when forming the first filter 125 on the resin film F as shown in FIG. 11 together with the other layer, the fluorescent layer is printed on the region to which the coloring ink is not adhered after printing the first background portion 125b using the green coloring ink to form the first indication portion 225a.

Referring to FIG. 13A, upon reception of the blue light 132a from the second light source 132, the light 132a transmits both the second indication portion 126a and the second background portion 126b of the second filter 126. In the first filter 125, the blue light is applied to the fluorescent layer formed on the first indication portion 225a so as to be excited to allow the first indication portion 225a to emit the white light. The blue light is not allowed to transmit the first background portion 125b of the first filter 125. Accordingly, the first indication portion 225a is displayed in the white fluorescent color, and the background portion other than the first indication portion 225a and the fixed display portion 129 appears dark.

Referring to FIG. 13B, the green light 131a applied from the first light source 131 transmits the second indication portion 126a of the second filter 126, and is blocked by the second background portion 126b. The green light which has transmitted the second indication portion 126a further transmits both the first background portion 125b and the first indication portion 225a of the first filter 125. The display state at this time is the same as the state shown in FIG. 12B.

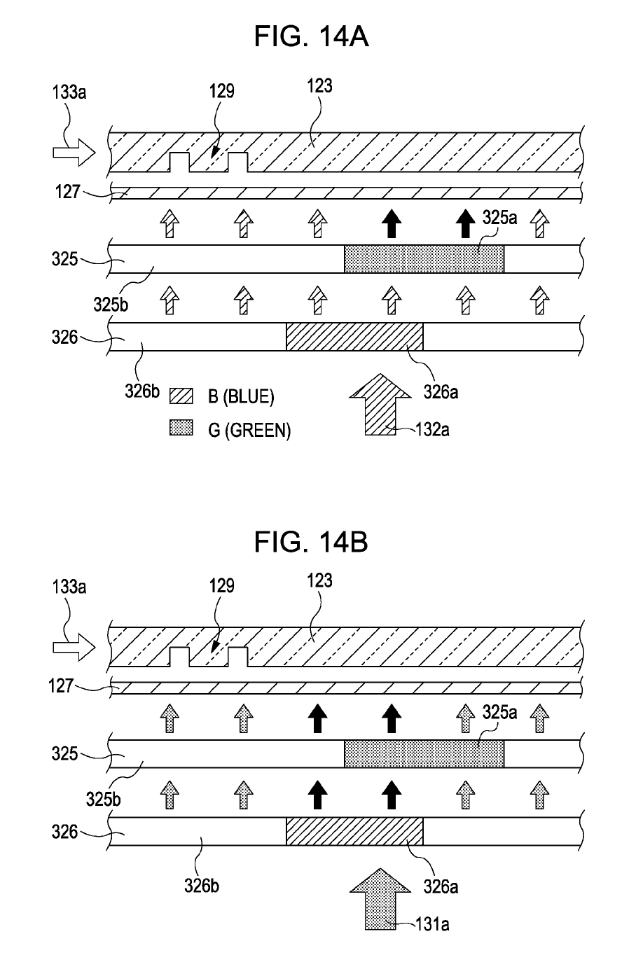

FIGS. 14A and 14B illustrate a display device according to a sixth embodiment of the present invention. The display device according to the sixth embodiment is substantially the same as the display device according to the fifth embodiment shown in FIGS. 12A and 12B except structures of a first filter 325 and a second filter 326.

In the sixth embodiment shown in FIGS. 14A and 14B, the green colored layer is formed on the first indication portion 325a of the first filter 325. The first indication portion 325a allows transmission of only the light at the wavelength band WG shown in FIG. 16. The first background portion 325b of the first filter 325 is not provided with the colored layer, and accordingly formed as the non-colored portion which allows transmission of the visible light with all the wavelengths.

The second indication portion 326a of the second filter 326 is provided with the blue colored layer so as to allow transmission of only the light at the wavelength band WB as shown in FIG. 16. The second background portion 326b is not provided with the colored layer, and accordingly formed as the non-colored portion which allows transmission of the visible light with all the wavelengths.

Referring to FIG. 14A, the blue light 132a emitted from the second light source 132 transmits both the second indication portion 326a and the second background portion 326b of the second filter 326. However, the blue light is not allowed to transmit the first indication portion 325a of the first filter 325.

Referring to the push button 120 shown in FIG. 8, the “Audio” on the first indication portion 325a is displayed dark by the side of the “Mode” shown on the fixed display portion 129, and the background of the fixed display portion 129 and the first indication portion 325a is entirely illuminated in blue.

Referring to FIG. 14B, the green light 131a emitted from the first light source 131 is blocked by the second indication portion 326a of the second filter 326, and allowed to transmit only the second background portion 326b. Meanwhile, the light 131a is allowed to transmit both the first indication portion 325a and the second background portion 325b of the first filter 325.

On the push button 120 shown in FIGS. 9A and 9B, the “Mail” on the second indication portion 326a is displayed dark by the side of the “Mode” on the fixed display portion 129. The background other than the fixed display portion 129 and the second indication portion 326a is brightly illuminated in green.

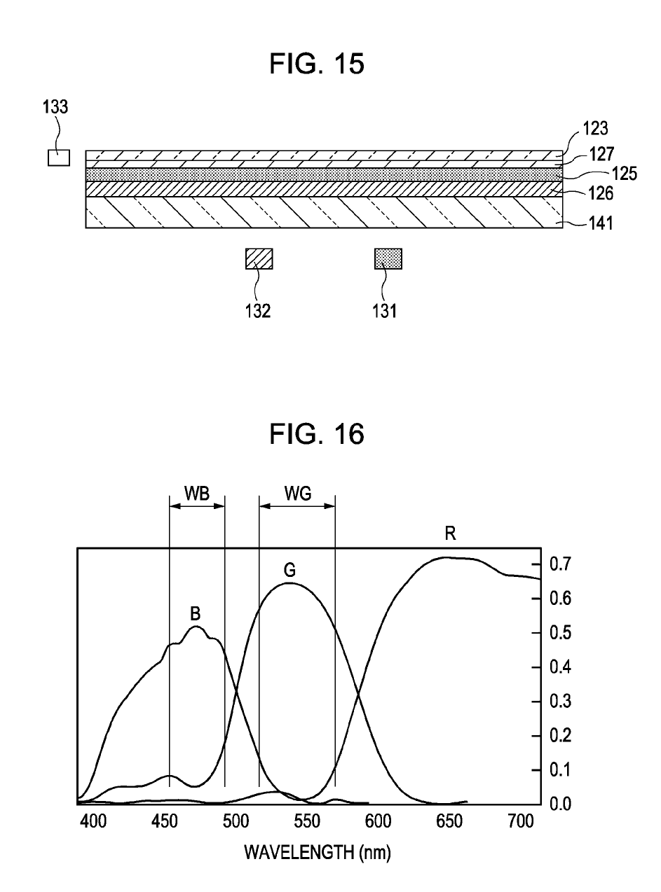

In the fifth and the sixth embodiments, the display device is provided on the push button 120. However, the display device according to the present invention is not limited to the one provided on the push button 120. For example, it may be combined with an input pad 141 of capacitance type as shown in FIG. 15. FIG. 15 illustrates the input pad 141 of capacitance type formed as light transmissive type.

The second filter 126 and the first filter 125 are laminated on the surface of the input pad 141, on which the transparent surface member 123 is formed via the half mirror layer 127. Referring to FIGS. 12A and 12B, the surface member 123 is provided with the fixed display portion 129. The first filter 125 includes the first indication portion 125a and the first background portion 125b, and the second filter 126 includes the second indication portion 126a and the second background portion 126b. The first light source 131 and the second light source 132 are provided below the input pad 141 of light transmissive type. The illumination light is applied from the illumination light source 133 to the surface member 123. The surface member 123 is formed of the transparent resin film.

The input pad 141 has plural X-electrodes and plural Y-electrodes oppositely arranged with the transparent insulating layer interposed therebetween. Both of the X-electrode and the Y-electrode are transparent. The drive circuit is driven to select the electrode from the plural X-electrodes and the plural Y-electrodes, to which the pulse voltage is applied. When the grounded conductive member such as a finger touches the surface of the surface member 123, the capacitance between the X- or Y-electrode and the finger is added to the capacitance between the X-electrode and the Y-electrode. As a result, the capacitance between the X-electrode and the Y-electrode is changed at the position touched by the finger. Determination with respect to the electrode to which the voltage is applied to decelerate the rise-up of the voltage between the electrodes allows detection of the location touched by the finger.

The light source is selectively changed to be illuminated between the first light source 131 and the second light source 132 to allow the display to be switched likewise the operation as shown in FIGS. 8, 9A and 9B. Referring to FIG. 15, the first filter 125 and the second filter 126 may be provided below the input pad 141.

What is claimed is:

1. A display device provided with a reflective display portion including an indication portion and a background portion, and a light emitting display portion positioned at an inner side of the reflective display portion, which allows a light emitted from the light emitting display portion to transmit the reflective display portion and to be observed, wherein:
the indication portion has a reflectance value with respect to the light, which is different from that of the background portion; and
a difference of a light transmittance value with respect to the light emitted from the light emitting display portion between the indication portion and the background portion is smaller than a difference of the reflectance value between the indication portion and the background portion.

2. The display device according to claim 1, wherein the indication portion has the light transmittance value with respect to the light emitted from the light emitting display portion, which is substantially the same as that of the background portion.

3. The display device according to claim 1, wherein the reflective display portion includes a reflective layer which makes each reflectance value of the indication portion and the background portion different, and a light limiting layer positioned at an inner side of the reflective layer for compensating the difference of the light transmittance value between the indication portion and the background portion caused by the reflective layer.

4. The display device according to claim 3, wherein:
the reflective display portion includes a translucent substrate;
the reflective layer is formed on an outer surface of the substrate; and
the light limiting layer is formed on an inner surface of the substrate.

5. The display device according to claim 3, wherein the reflective display portion includes a translucent substrate, and both the reflective layer and the light limiting layer are formed on an inner surface of the substrate.

6. The display device according to claim 5, further comprising an illumination unit for illuminating the reflective display portion.

7. The display device according to claim 1, wherein:
the light emitting display portion is provided with a first display portion which includes an indication portion and a background portion, a second display portion which includes an indication portion and a background portion, a first light emitting portion for emitting a light with a first wavelength, and a second light emitting portion for emitting a light with a second wavelength which is different from the first wavelength;
a difference of the light transmittance value with respect to the light with the first wavelength between the indication portion and the background portion of the first display portion is smaller than a difference of the light transmittance value with respect to the light with the first wavelength between the indication portion and the background portion of the second display portion; and
a difference of the light transmittance value with respect to the light with the second wavelength between the indication portion and the background portion of the second display portion is smaller than a difference of the light transmittance value with respect to the light with the second wavelength between the indication portion and the background portion of the first display portion.

8. The display device according to claim 7, wherein:
the light transmittance value with respect to the light with the first wavelength of the indication portion of the first display portion is substantially the same as that of the background portion of the first display portion; and
the light transmittance value with respect to the light with the second wavelength of the indication portion of the second display portion is substantially the same as that of the background portion of the second display portion.

9. The display device according to claim 1, wherein:
the reflectance value with respect to the light with a specific wavelength, and a hue observed upon application of an external light become different between the indication portion and the background portion of the reflective display portion; and
the light transmittance value with respect to the light with the wavelength emitted from the light emitting display portion of the indication portion of the reflective display portion is substantially the same as that of the background portion of the reflective display portion.

10. The display device according to claim 7, wherein:
the reflectance value with respect to the light with a specific wavelength, and a hue observed upon application of an external light become different between the indication portion and the background portion of the reflective display portion; and
the light transmittance value with respect to the light with the first wavelength is substantially the same as the transmittance value with respect to the light with the second wavelength between the indication portion and the background portion of the reflective display portion.

11. A display device provided with a first filter and a second filter which are laminated, and a first light source and a second light source each having a different center wavelength at a light emitting wavelength band, wherein:
the first filter includes a first indication portion and a first background portion, and the second filter includes a second indication portion and a second background portion;
a difference of a transmittance value of a light from the second light source between the first indication portion and the first background portion is larger than a difference of a transmittance value of the light from the second light source between the second indication portion and the second background portion;
a difference of the transmittance value of the light from the first light source between the second indication portion and the second background portion is larger than the difference of the transmittance value of the light from the first light source between the first indication portion and the first background portion;
a contrast between the second indication portion and the second background portion of the second filter is displayed upon transmission of the light from the first light source through the first filter and the second filter, and a contrast between the first indication portion and the first background portion of the first filter is displayed upon transmission of the light from the second light source through the first filter and the second filter;
a surface member which transmits the light is formed on each surface of the both filters, a fixed display portion is provided for the surface member, and the fixed display portion is observed in both cases where the light is applied from the first light source and the light is applied from the second light source; and
a light source for illuminating the fixed display portion is provided for emitting the light to illuminate the fixed display portion through a path separated from a path of the light from the first and the second light sources.

12. The display device according to claim 11, wherein a half mirror layer for reflecting a part of the light and transmitting the other part of the light is provided between both the filters and the surface member.

13. The display device according to claim 11, wherein the light source for the fixed display illumination applies the light to a portion closer to a surface side than the half mirror layer.

14. The display device according to claim 11, wherein:
the first and the second filters are formed inside a pressure member for pressing a dome member; and
the fixed display portion is formed inside the surface member with a button-like shape for driving the pressure member.
